(19) United States
(12) Patent Application Publication
(10) Pub. No.: US 2012/0087847 A1
(43) Pub. Date: Apr. 12, 2012

(54) FILTERING TUBE AND MICROTUBE FOR THE PREPARATION AND PURIFICATION OF SMALL SAMPLE VOLUMES

(76) Inventors: Roy Garvin, Central Point, OR (US); Alasdair Burns, Ashland, OR (US); Andrea Ciaston, Central Point, OR (US)

(21) Appl. No.: 13/267,345

(22) Filed: Oct. 6, 2011

Related U.S. Application Data
(63) Continuation of application No. PCT/GB2010/000691, filed on Apr. 6, 2010.

(30) Foreign Application Priority Data
Apr. 6, 2009 (GB) 0905967.6

(51) Int. Cl. B01L 3/14

(52) U.S. Cl. 422/533; 422/548

(57) ABSTRACT

The present invention relates to spin baskets or columns used in the preparation and purification of small sample volumes. The spin baskets of the invention are particularly designed to be used with microtubes and are adapted to connect with such microtubes.

This application is a continuation of and claims benefit under 35 U.S.C. § 120 from International Application No. PCT/GB2010/000691, having an International Filing Date of Apr. 6, 2010, which claims priority from GB Application No. 0905967.6, having a filing date of Apr. 6, 2009.

The present invention relates to spin baskets or columns used in the preparation and purification of small sample volumes. The spin baskets of the invention are particularly designed to be used with microtubes and are adapted to connect with such microtubes.

The purification of small biological and chemical samples is central to biotechnological and biomedical research. Spinning samples through through filtration membranes, using spin baskets or columns, which can be filled with different absorption materials and eluting samples from a solid material are among the most common techniques for purifying and separating small sample volumes.

Spin baskets are essentially small tubes with a filter or fritte at their base that enables purification or separation (or both) by centrifugation. Solid material can also be added to the tube for absorption or separation of particles. This is referred to as a spin column. As the structure of a spin basket and a spin column is essentially the same, “spin basket” is the term that will be used herein.

The sample is introduced at the top of the basket and centrifugation results in the elution, purification or component alteration of the sample as it passes through the basket. The spin basket sits within a microtube that collects the filtered residue of the sample. As used herein the term “microtube” is intended to encompass any laboratory container, e.g., a small test tube or microcentrifuge tube suitable for storing or centrifuging small amounts of liquid, for example 2 ml, 1.5 ml, 0.5 ml or 0.2 ml tubes. In use the lid of the microtube is inserted into the top of the column creating a sealed unit.

Currently many different types of spin baskets are available in the market. Spin baskets tend to comprise a container with a filter at the bottom and either a frictional pressure seal or no sealing system at the side or top. The baskets either rest on the lip of a microtube or pressure is applied to create the friction necessary to engage the sealing system. Following use the basket is extracted with a pair of forceps or grasped between the thumb and forefinger to unseat and extract it from the microtube.

Spin baskets currently in use suffer from certain problems in use. Firstly, there is a risk of contamination during or after centrifugation and while removing the basket from the microtube. The spin baskets and microtubes generally used in centrifugation are made of injection moulded plastic. The absence of any locking system in certain systems on the market can allow sample to leak out of the spin basket/microtube apparatus during use and handling. The pressure applied to engage the frictional seal in other systems can cause the plastic baskets and/or microtubes to stretch or deform such that the lid no longer creates a seal, which can result in leakage during subsequent steps. This leakage can cause contamination of the sample, tube and user.

During extraction of the spin basket from the microtube the forceps and fingers can make contact with the top of the tube creating further risk of contamination to the sample, tube and user. Direct contact between the operator's forefinger and thumb or forceps and the top of the spin basket must be made to extract it from the microtube. This movement is awkward and cumbersome and as such increases the risk of spilling samples while extracting the spin basket from the microtube.

The present invention provides an advantageous system which uses a spin basket with straight sides and a locking system which eliminates the pressure placed on the spin basket/microtube apparatus during centrifugation. This in turn prevents any stretching or deformity of the microtube or spin basket which would otherwise lead to leakage and contamination in subsequent steps. In the present invention a seal is created between a ring on the spin basket and the inner wall of the microtube by means of a locking system. The lid of the microtube also creates a seal by means of a locking system between a ring on its exterior surface and a ring on the inner wall of the spin basket thus creating a sealed unit for centrifugation.

This sealing mechanism eliminates any pressure on the tube and the spin basket during centrifugation thus eliminating any stretching or deformity of the tube or spin basket. Therefore, when the spin basket is removed and the lid is closed the, seal between the lid and the tube opening remains intact. In addition, the spin basket can also include a flange which will facilitate removal/extraction of the spin basket. This in turn eliminates further pressure on the spin basket/microtube apparatus again reducing the risk of contamination and spillage of the sample and/or contamination after centrifugation.

Thus, in a first aspect, the present invention provides a spin basket having an open end suitable for receiving materials and a base comprising a filter or fritte, a first locking member adapted to engage with the lid of a micro tube such that a seal is formed between said first locking member and the microtube lid and a second locking member formed on the exterior of the spin basket and adapted to engage with at least a part of the internal surface of a microtube.

Preferably, the spin basket has substantially perpendicular sides and also preferably comprises at least one flange which acts as a handle for manipulating the spin basket.

Suitably, the spin basket is formed of injection moulded plastic and the locking members and/or flange(s) are formed as an integral part of the spin basket. Generally, the locking members are projections which extend around the entire circumference of the spin basket and thus serve to form a seal with the corresponding members formed on the microtube.

The microtubes described herein are not “conventional” in the sense that they comprise a locking member formed on their interior wall designed to engage with a corresponding locking member formed on the spin basket. Thus, in a second aspect, the present invention provides a microtube comprising a locking member formed on its interior surface and adapted to engage with a corresponding locking member formed on a spin basket.

Although, in preferred embodiments described herein, the spin basket of the invention is designed to be used in conjunction with a microtube comprising locking members, it will be understood that the spin basket of the invention can be used with “conventional” microtubes, which do not comprise corresponding locking members of their own. The locking member formed on the spin basket may effectively still provide a seal when the spin basket is inserted into the microtube, although it may not be as effective as the seal formed by interlocking with corresponding locking members formed on the interior of the micro tube.

In a third aspect the present invention provides a system comprising a spin basket of the invention together with a microtube. Preferably, the microtube has a locking member designed to engage with a corresponding locking member formed on the spin basket.

The spin baskets can contain filtration and/or chromatographic media.

In a further aspect, the invention provides a kit comprising a spin basket of the invention together with at least one microtube. Preferably the microtube is a microtube according to the second aspect of the invention.

The invention will now be described with reference to the drawings in which:

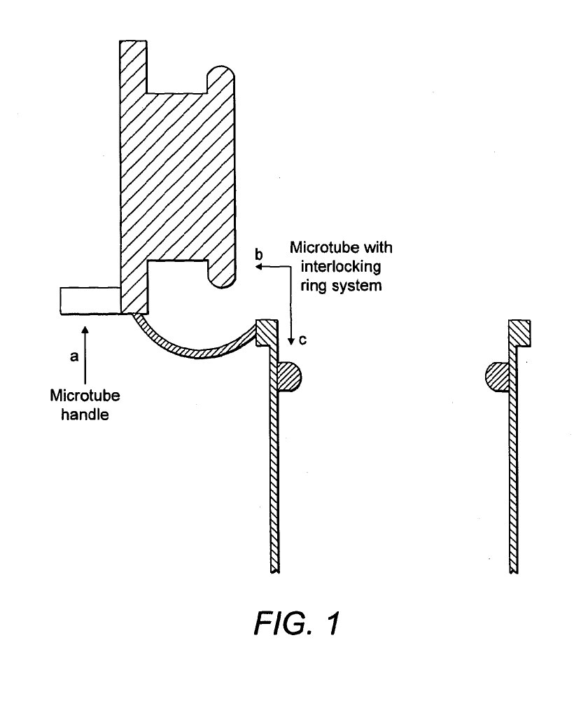

FIG. 1: shows a cross-section of a microtube with the lid open wherein a is a handle attached to the lid of the microtube to assist with opening and closing of the microtube. An upward force is applied to the handle allowing the lid to be opened without contact with any other part of the lid. Parts b and c show the interlocking members which effect a seal between the micro tube and the lid.

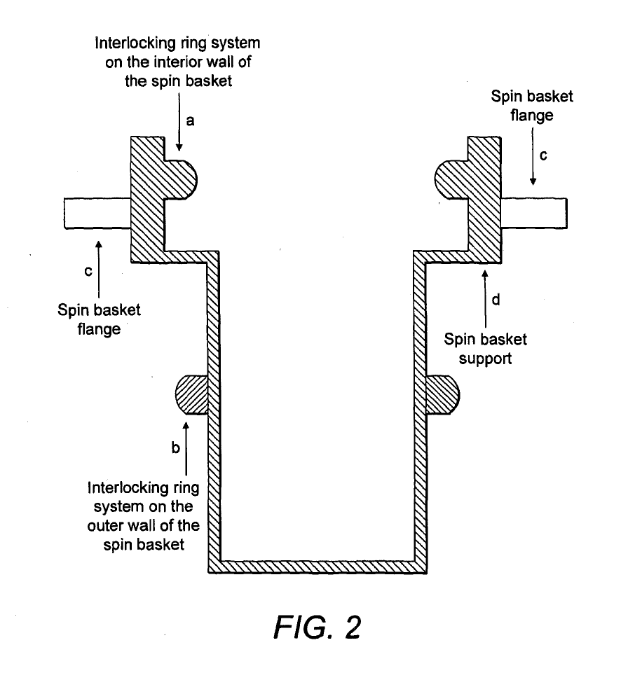

FIG. 2: shows the cross-section of the spin basket having a locking system. Part d is formed as part of the spin basket in order to provide a support which in use rests on the top of the microtube. Part c is the flange formed on the spin basket which in use can be used to grasp when removing the spin basket from the microtube. Part a is the locking member which is designed to engage with a corresponding member formed on the lid of the microtube. Part b is the locking member formed on the exterior wall of the spin basket and designed to engage with a corresponding member formed on the interior wall of the microtube.

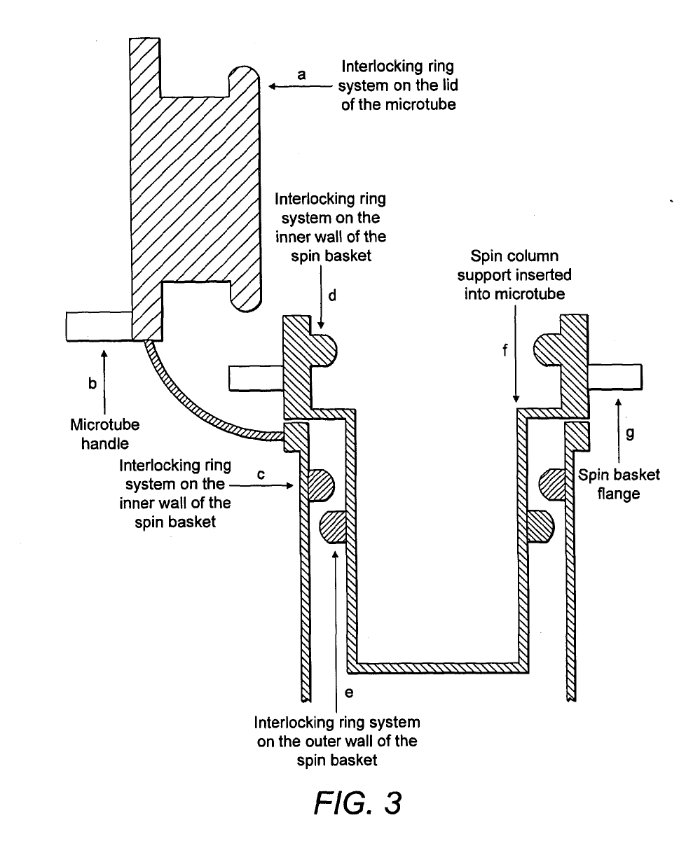

FIG. 3: shows the combination of spin basket and microtube wherein the spin basket is inserted in the open top of the microtube and the locking member on the interior surface of the microtube has engaged with the corresponding locking member on the spin basket.

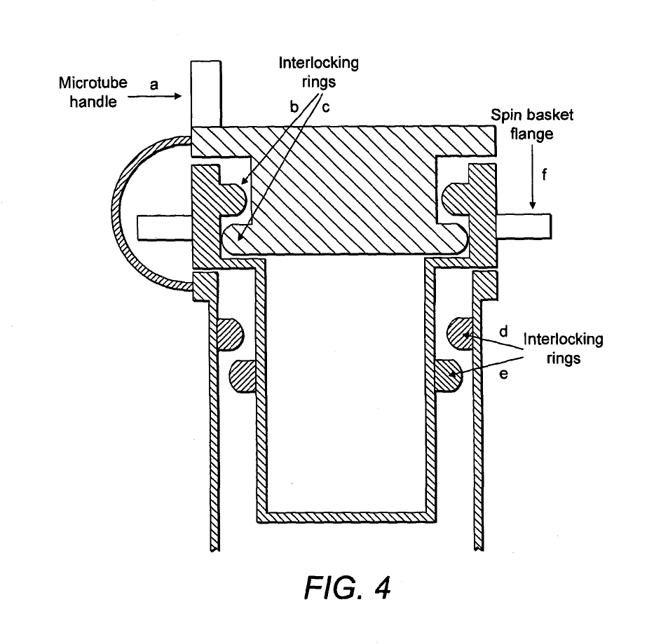

FIG. 4: shows the combination of FIG. 3, but now the lid of the microtube is closed. Thus, the locking member formed on the lid of the microtube is now engaged with the corresponding locking member formed near the open end of the spin basket.

1. A spin basket having an open end suitable for receiving materials and a base comprising a filter or fritte, a first locking member adapted to engage with the lid of a microtube such that a seal is formed between said first locking member and the microtube lid and a second locking member formed on the exterior of the spin basket and adapted to engage with at least a part of the internal surface of a microtube.

2. A spin basket as claimed in claim 1, wherein the spin basket has substantially perpendicular sides.

3. A spin basket as claimed in claim 1, wherein the spin basket comprises at least one flange which acts as a handle.

4. A spin basket as claimed in claim 1, wherein the spin basket is formed of injection moulded plastic.

5. A spin basket as claimed in claim 1, wherein the locking members and/or flange(s) are formed as an integral part of the spin basket.

6. A spin basket as claimed in claim 1, wherein one or both of the locking members are formed by projections which extend around the entire circumference of the spin basket and thus serve to form a seal with the corresponding members formed on the microtube.

7. A spin basket as claimed in claim 1, which contains filtration and/or chromatographic media.

8. A microtube comprising a locking member formed on its interior surface and adapted to engage with a corresponding locking member formed on a spin basket.

9. A kit comprising a spin basket as claimed in claim 1 and at least one microtube.

10. A kit as claimed in claim 9, wherein the at least one microtube is as claimed in claim 8.
